(19) United States
(12) Patent Application Publication
(10) Pub. No.: US 2006/0073091 A1
(43) Pub. Date: Apr. 6, 2006

(54) Process for producing lithium transition metal oxides

(76) Inventors: Feng Zou, Mississauga (CA); Mohammad Jahangir Hossain, Mississauga (CA)

Correspondence Address: INCO PATENTS & LICENSING, PARK 80 WEST - PLAZA TWO, SADDLE BROOK, NJ, 07663, US

(21) Appl. No.: 10/957,396

(22) Filed: Oct. 1, 2004

(51) Int. Cl. C01G 45/02

(52) U.S. Cl. 423/594.6; 423/599

(57) ABSTRACT

A direct low temperature process for lithiating hydroxides and forming lithiated transition metal oxides of suitable crystallinity. Elemental transition metal powders are combined with an aqueous solution of lithium hydroxide. The aqueous slurry solution is subject to oxidation. The resultant lithium transition metal oxide is crystallized in-situ and subsequently removed from the reactor.

### TECHNICAL FIELD

The present invention relates to the production of lithium transition metal oxides in general and to the direct conversion of transition elemental metal powders to lithium metal oxide particles in particular.

### BACKGROUND OF THE INVENTION

With the continuing remarkable development of electronic apparatus such as portable computers, cell phones, cameras, personal digital assistants (PDA's) electric vehicles, etc. there has been a strong demand for the enhancement of the performance of the batteries used to supply power for these devices. Lithium battery systems are becoming the battery system of choice because of their superior energy density and power density over other rechargeable battery technologies.

Lithium cobalt dioxide (LiCoO₂) is the major active cathodic material currently used in lithium batteries.

Typically, most commercial lithium cobalt oxide is made by a solid-state reaction between a lithium compound and a cobalt compound occurring at high temperatures (900-950° C.) for many hours. This process requires several steps involving lengthy heat treatments combined with good mixing steps such as ball milling or other fine grinding methods. Variations include aqueous solutions, extensive pre-mixing, mechanical alloying, sol-gel, spray drying, solution combustion, catalysts, co-precipitation, hydrothermal methods, etc. Often, these processes are complex or produce pollutants that must be treated.

In addition, other lithium metal oxides have been extensively studied as alternatives to LiCoO₂. Among them, Ni/Mn or Ni/Mn/Co based mixed lithium oxides with layered structures are considered promising substitute cathode materials for lithium batteries with better performance including large scale automotive applications than the currently used LiCoO₂. Again, complex, cumbersome, high temperature solid-state reactions are generally used to produce these materials.

Accordingly, there is a need for a simple, low temperature process for producing crystallized mixed lithiated metal oxides.

### SUMMARY OF THE INVENTION

There is provided a low temperature, environmentally friendly process for producing lithium transition-metal oxide with spherical or elliptic particle shapes directly from the metallic form of the transition metal in an aqueous solution containing lithium ion with a pH more than about 13. The transition metal could be a single element or combination of them suitable for lithium energy cells including cobalt, manganese, nickel, etc. An oxidizing environment, for example an oxidant, such as oxygen, or an oxygen containing gas such as air, hydrogen peroxide, ozone, hypochloride, or persulfate, is introduced into the solution and the mixture is heated to above 30° C.

### BRIEF DESCRIPTION OF THE DRAWINGS

FIG. 1 is an x-ray diffraction spectrum pattern of various timed samples made in accordance with an embodiment of the invention.

FIG. 2 is photomicrograph of a sample made in accordance with an embodiment of the invention.

FIG. 3 is a photomicrograph of a sample made in accordance with an embodiment of the invention.

FIG. 4 is an x-ray diffraction pattern of a sample made in accordance with an embodiment of the invention.

FIG. 5 is a charge/discharge graph of a cell made in accordance with an embodiment of the invention.

FIG. 6 is an x-ray diffraction pattern of samples made in accordance with an embodiment of the invention.

FIG. 7 is an x-ray diffraction pattern of samples made in accordance with an embodiment of the invention.

### PREFERRED EMBODIMENTS OF THE INVENTION

The adverb “about” before a series of values will be construed as being applicable to each value in the series unless noted to the contrary.

As noted above, LiCoO₂ is currently used as a cathodic material in lithium battery systems. Other single or mixed LiMO₂ (M=Ni, Mn, Co, Fe, etc.) compounds are also under development.

The present low temperature process for making a lithiated oxide is relatively simple and more efficient when compared to current commercial techniques.

In the present process, metallic transition metals such as Co, Mn, Fe and Ni may be used directly to make lithium metal oxide. The aforementioned elements are specifically identified as components of lithium cells. However, the process is applicable to any transition metal. According to potential-pH equilibrium diagrams transition metals are not stable under high alkaline (pH>13) and oxidizing (slightly high potential) conditions. As a result, soluble species such as HMO₂⁻ (M=Co, Ni, Mn, Fe, etc.) may be formed. The oxidizing conditions can be created chemically, e.g. introducing an oxidant into the system, or electrochemically, e.g. applying anodic current to the metals.

By combining the transition metal, lithium hydroxide and source of oxidation, a reaction occurs causing lithium metal oxide to precipitate immediately after the metallic metal dissolves in solution.

The overall reaction is believed to be represented by the following equation for the case of using oxygen as the oxidant:
4M+4LiOH+3O₂→4LiO₂+2H₂O (M=Co, Mn, Ni, or mixtures thereof)

The above referenced reaction may be carried out at atmospheric pressure, at temperatures equal to and above ambient temperature, and with a pH equal to and above about 13. However, in order to accelerate the kinetics of the reactions, the operating temperature and pH preferably should be increased, e.g. temperature at 100° C. and pH at 14.5. Operating at levels greater than about atmospheric pressure may also increase the kinetics of the process although higher pressures inevitably raise cost issues. Even though other alkaline materials such as NaOH and KOH may be used to adjust pH, it is preferable to use LiOH for pH adjustment to eliminate any potential contamination. In the following examples, metallic metal powders were used as starting materials. However, the process is not so limited thereto. In principle, any metallic metal form can be used in this process.

The benefits using the present invention over current commercial processes include:

1) The avoidance or substantial shortening of the subsequent high temperature crystallization heat treatment as compared to the conventional solid reaction route. If desired, an optional heat treatment at about 850° C. for about 0.5-4 hours appears to provide additional results, as opposed to conventional 12-30 hour multiple-stage heat treatment regimens.

The present process generates lithiated layered cobalt oxide (space group: R-3m) with (003)FWHM (Full Width at Half Maximum) and (104)FWHM of about 0.5° without the need for a subsequent heat treatment. If higher crystallinity levels are desired, a subsequent heat treatment step may be utilized. However, in contrast to the prior art since the lithiated oxide compound is already sufficiently crystallized, the time for the optional heat treatment step to raise crystallinity higher is significantly shorter by an order of about one magnitude.

In light of the enhanced initial crystallinity levels, if needed, the heat treatment may be carried out from about 300° C. to 1100° C.

2) Spherical particles with high tap density can be obtained. Because the present process can be considered as a type of co-precipitation process, the particles generally grow with the time of the reaction and reaction conditions such as agitation and slurry density. This results in better control of both powder size and morphology. Moreover, the entire prior art ball milling process or other mixing process is eliminated.

3) By utilizing a relatively low processing temperature below about 150° C. a desirable lithiated product is sufficiently formed. Therefore the problems associated with diffusion and atmospheric controls for heat treatment are reduced.

As a result of the improved morphologies and less critical control demands brought by lower temperature processing, production efficiencies may be realized since a continuous rotary furnace may be employed for heat treatment rather than a batch static furnace.

4) There will be no effluent generation with present process because the liquid can be totally reused after standard liquid/solid separation.

It is believed that at least one molar solution of lithium hydroxide is required for the process to operate at ambient temperatures. However, a higher concentration of lithium hydroxide is more favorable to complete the reaction mentioned above. As the temperature of the reaction is increased, the solubility of the lithium hydroxide increases as well. It is believed that an about 8 molar lithium hydroxide aqueous solution can be obtained at a temperature around 100° C.

In order to ensure the success of the examples below, the metallic powder is introduced along with solid lithium hydroxide (LiOH.H₂O) into the aqueous lithium hydroxide solution so as to have sufficient lithium hydroxide in the solution. In commercial practice, the most expeditious way of supplying lithium hydroxide should be utilized.

If desired doping elements such as aluminum and magnesium may be added to the aqueous solution.

A number of experiments were run to demonstrate the efficacy of the present invention.

### EXAMPLE 1

250 g metallic cobalt powder together with 250 g LiOH.H₂O was introduced into a 3000 mL vessel having a 1500 mL LiOH aqueous solution with a concentration about 3M at atmospheric pressure. The temperature of the slurry was maintained between about 80-120° C. The slurry was agitated with an impeller at 700 revolutions per minute. 40 g of LiCoO₂ (lithium cobalt oxide) with averaged particle size of 2 μm was also introduced into the vessel as seeds. To start the reaction, oxygen gas was continuously introduced into the vessel at a flow rate of about 150-200 mL per minute. The reaction lasted 104 hours. About 50 g LiCoO₂ samples were taken out respectively at 10 hour, 34 hour, 58 hour, 82 hour and 104 hour of reaction time with magnetic separations from the unreacted cobalt and water wash. After each sampling, 220 g cobalt powder and 150 g LiOH.H₂O were added into the reacting system.

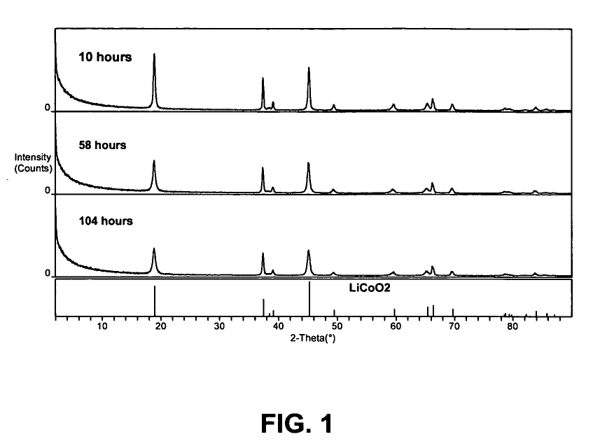

Table 1 shows the results of lithium to cobalt molar ratio with inductively coupled plasma (ICP) analysis and the particle size measured using a Microtrac® particle size analyzer for each sample. Continuously increasing in particle size indicates that newly formed product could precipitate on the surface of existing particles. However, the Li/Co molar ratios for all the samples were about 1.00 as expected for a completed reaction to produce LiCoO₂, which implies that LiCoO₂ was produced instantly under the reaction. The XRD (x-ray diffraction) spectra for each sample show a single layered LiCoO₂ phase as seen in representation sample curves in FIG. 1, which supports above conclusion of LiCoO₂ formation. For comparison purposes, FIG. 1 also shows a standard LiCoO₂ XRD pattern just above the X-axis.

TABLE 1

| Reaction time (hours) | Li/Co molar ratio | Particle size D₅₀ (μm) |
|---|---|---|
| 10 | 1.01 ± 0.02 | 3.76 |
| 34 | 1.01 ± 0.02 | 4.82 |
| 58 | 1.00 ± 0.02 | 6.08 |
| 82 | 0.99 ± 0.02 | 7.06 |
| 104 | 1.01 ± 0.02 | 7.99 |

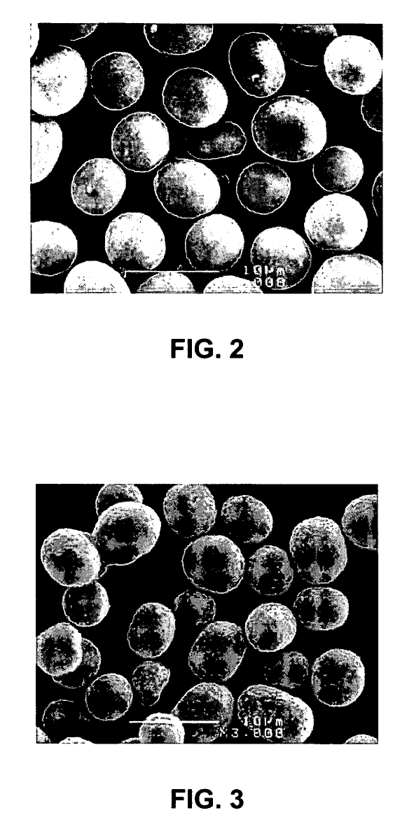

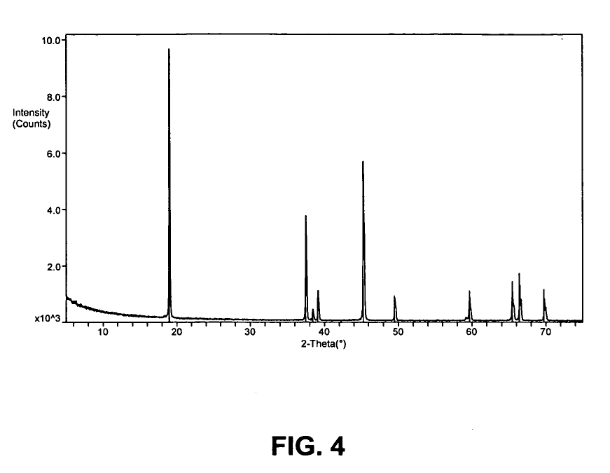

SEM (scanning electron microscope) image of the sample taken at 104 hour of reaction time is shown in FIG. 2. It can be seen that the particles are quite spherical with smooth surfaces. In order to increase the crystallinity, a one-hour heat treatment was performed at 880° C. There was no change in the particle shape after the heat treatment as seen in FIG. 3. The XRD spectrum for the sample with the heat treatment showed that crystal structure was still a layered LiCoO₂ structure but the crystallinity was changed as seen in FIG. 4. The FWHM of (003) and (104) was 0.55° and 0.47° respectively for the sample before heat treatment but was 0.10° and 0.12° for the sample after heat treatment. The tap density of the sample after heat treatment was about 2.6 g/cm³, and the surface area measured by the Brunauer-Emmett-Teller (BET) method was about 0.78 m²/g.

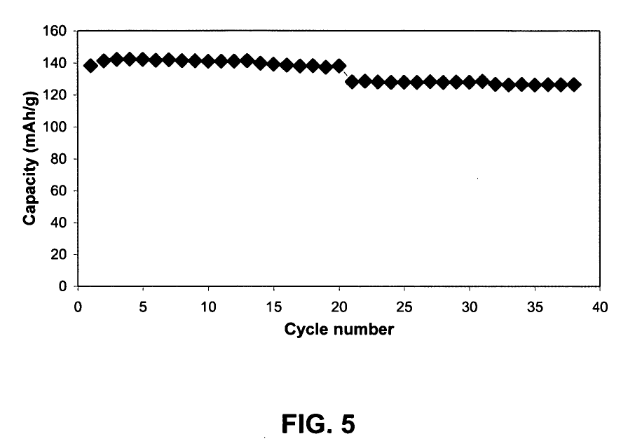

In order to test the electrochemical performance of the above LiCoO2 material, a Swagelok® type cell with three-electrode system was used in which Li metal was used for both counter and reference electrodes. The electrolyte solution is 1 M LiPF₆ in ethylene carbonate/dimethyl carbonate (EC/DMC, 1:1). FIG. 5 shows the test results with C/5 charge/discharge rate. The charge/discharge voltage window was 3.0V to 4.3V for the first twenty cycles and 3.7V to 4.3V for the remaining cycles. The discharge capacity of the material was stabilized at about 140 mAh/g for 3.0-4.3V window and about 130 mAh/g for 3.7-4.3V window.

### EXAMPLE 2

250 g metallic cobalt powder together with 400 g LiOH.H₂O was introduced into a 3000 mL vessel having a 1500 mL LiOH aqueous solution with a concentration of 3M at atmospheric pressure. The temperature of the slurry was maintained between about 80-120° C. The slurry was agitated with an impeller at 720 revolutions per minute. In contrast to example 1, there was no LiCoO₂ introduced into the vessel as seeds. To start the reaction, oxygen gas was continuously introduced into the vessel at a flow rate of about 100 mL per minute. 385 g of product was obtained after 45 hours reaction with magnetic separations from the unreacted cobalt and water wash. By ICP analysis and XRD examination, the product was pure LiCoO2 as expected. The conversion of the reaction was about 92%.

### EXAMPLE 3

250 g metallic cobalt powder together with 400 g LiOH.H₂O was introduced into a 3000 mL vessel having a 1400 mL LiOH aqueous solution with a concentration of 3M at atmospheric pressure. The temperature of the slurry was maintained between about 90-110° C. The slurry was agitated with an impeller at 700 revolutions per minute. About 40 g of LiCoO₂ was also introduced into the vessel as seeds. Instead of using oxygen as in example 1, air was continuously introduced into the vessel at a flow rate of about 320 mL per minute. 190 g of product was obtained after 48 hours reaction with magnetic separations from the unreacted cobalt and a water wash. By ICP analysis and XRD examination, the product was pure LiCoO2 as expected. The conversion of the reaction was about 46%.

### EXAMPLE 4

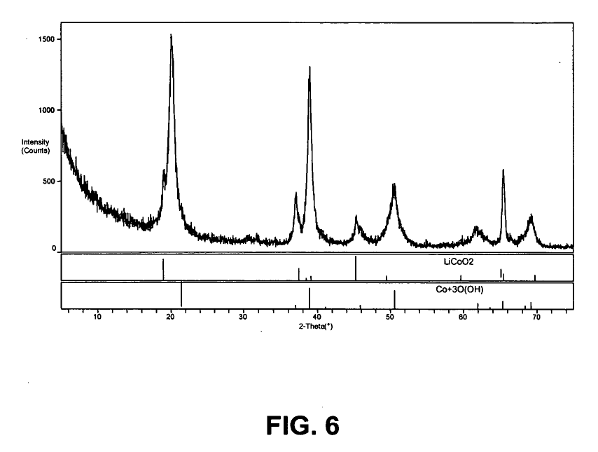

250 g metallic cobalt powder together with about 400 g LiOH.H₂O was introduced into a 300 mL vessel having a 1400 mL LiOH aqueous solution with a concentration of 3M at atmospheric pressure. The temperature of the slurry was maintained at room temperature, i.e. about 25-30° C. The slurry was agitated with an impeller at 700 revolutions per minute. 40 g of LiCoO₂ was also introduced into the vessel as seeds. Oxygen was continuously introduced into the vessel at a flow rate of 100 mL per minute. 405 g of product was obtained after 67 hours reaction time with magnetic separations from the unreacted cobalt and water wash. By XRD examination, the product was a mixture of LiCoO₂ and CoOOH as seen in FIG. 6. ICP analysis result showed that the Li to Co molar ratio was only 0.34, which implied that only 34% of Co was LiCoO2 and the rest was CoOOH, even through about 98% Co powder was reacted. For comparison purposes, standard LiCoO2 and CoOOH are shown above the X-axis.

### EXAMPLE 5

250 g metallic cobalt powder together with 400 g LiOH.H₂O was introduced into a 3000 mL vessel having a 1400 mL LiOH aqueous solution with a concentration of 3M at atmospheric pressure. The temperature of the slurry was maintained at about 90-100° C. The slurry was agitated with an impeller at 700 revolutions per minute. 30 g of LiCoO₂ was also introduced into the vessel as seeds. Instead of using oxygen, H₂O₂ (30% solution) was continuously introduced into the vessel at an averaged flow rate of about 1.0 mL per minute. About 420 g of product was obtained after about 45 hours reaction with magnetic separations from the unreacted cobalt and water wash. By XRD examination, the product was LiCoO₂. ICP analysis result showed that the Li to Co molar ratio was about 1.0. The Co conversion was almost 100%.

### EXAMPLE 6

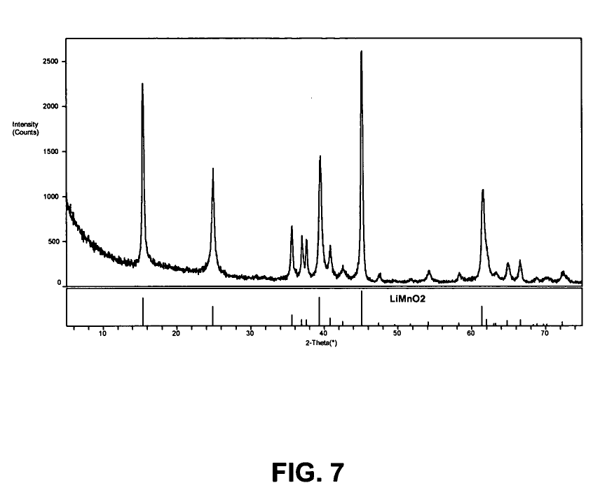

250 g metallic manganese powder together with 400 g LiOH.H₂O was introduced into a 300 mL vessel having a 1500 mL LiOH aqueous solution with a concentration of 3M at atmospheric pressure. The temperature of the slurry was maintained about 90-100° C. The slurry was agitated with an impeller at 700 revolutions per minute. 30 g of fresh prepared Mn(OH)₂ was also introduced into the vessel as seeds. Oxygen was continuously introduced into the vessel at a flow rate of 100 mL per minute. 415 g of product was obtained after about 31 hours reaction with the water wash. By XRD examination, the product was LiMnO₂ (lithium manganate) as seen in FIG. 7. ICP analysis result showed that Li to Mn molar ratio was about 1.03. For comparison purposes, standard LiMnO₂ is shown in FIG. 7.

### EXAMPLE 7

208 g metallic cobalt powder was introduced into a 3000 mL vessel having a 1400 mL LiOH aqueous solution with a concentration 8M at atmospheric pressure. The temperature of the slurry was maintained at 100° C. The slurry was agitated with an impeller at 700 revolutions per minute. Oxygen was continuously introduced into the vessel at a flow rate of about 150 mL per minute. After 30 minutes of introducing oxygen, 2 g of manganese powder was added into the reacting system every one hour for 14 hours, i.e. total 28 g Mn powder added into the reactor. After one hour from the last Mn powder addition, the reaction was terminated and about 140 g product was collected with magnetic separations from the unreacted cobalt and water wash. ICP analysis result showed that Mn/Co molar ratio was 0.5 and Li to (Co+Mn) molar ratio was 1.04. XRD spectrum of the product showed a similar structure as layered LiCoO₂. The expected peak shifting slightly toward lower degree direction, which was due to the larger Mn ion replacing Co in the lattice was also observed. All these results suggest that a mixed Li(Mn_{1/3}Co_{2/3})O₂ was formed.

In principle, any size of the initial elemental metal powder may be used in present process. By judicious adjustment and timing of the reaction the resultant lithium transition metal oxides may range from about 0.1 μm to 30 μm.

The present process is an exquisite simplification of current somewhat cumbersome processes to produce ever finer and purer lithium transition metal oxides. Taking basic elemental pure metal powders and transforming them into the finished product in an economically and environmentally friendly is a decided advance over the current state of the art.

While in accordance with the provisions of the statute, there is illustrated and described herein specific embodiments of the invention. Those skilled in the art will understand that changes may be made in the form of the invention covered by the claims and that certain features of the invention may sometimes be used to advantage without a corresponding use of the other features.

What is claimed is:

1. A process for producing lithium transition metal oxide, the process comprising:
a) providing an aqueous solution of LiOH,
b) introducing M elemental metal into the aqueous solution wherein M elemental metal is selected from a group consisting of at least one transition metal;
c) creating an oxidizing environment in the aqueous solution,
d) agitating the aqueous solution;
e) causing the resultant lithium transition metal oxide to crystallize in-situ; and
f) collecting the resultant lithium transition metal oxide from the aqueous solution.

2. The process according to claim 1 wherein the transition metals are selected from at least one of a group consisting of nickel, cobalt, manganese, and iron.

3. The process according to claim 1 wherein the pH of the aqueous solution is at least about 13.

4. The process according to claim 1 wherein the temperature of the aqueous solution is at least about 30° C.

5. The process according to claim 1 wherein M elemental metal is a powder.

6. The process according to claim 1 wherein the oxidizing environment is created by an oxidant.

7. The process according to claim 6 wherein the oxidant is selected from at least one of the group consisting of oxygen, air, hydrogen peroxide, ozone, hypochloride, and persulfate.

8. The process according to claim 1 wherein the pH of the aqueous solution is modulated by the addition of an alkaline selected from at least one of a group consisting of LiOH, NaOH and KOH.

9. The process according to claim 1 wherein the resultant lithium transition metal oxide is subjected to a crystallization heat treatment.

10. The process according to claim 9 wherein the crystallization heat treatment is conducted for about 300° C. to 1100° C.

11. The process according to claim 8 wherein the crystallization heat treatment is conducted for about 0.5 to 4 hours.

12. The process according to claim 1 wherein additional resultant lithium transition metal oxide is introduced into the aqueous solution as seed.

13. The process according to claim 1 wherein LiOH.H₂O is co-introduced with M elemental metal into the aqueous solution of LiOH to create at least a one molar aqueous solution of lithium hydroxide.

14. The process according to claim 1 wherein the temperature of the aqueous solution ranges from about 25° C. to 150° C.

15. The process according to claim 1 wherein the process is conducted at about atmospheric pressure.

16. The process according to claim 1 wherein the resultant lithium transition metal oxide is at least essentially spherical.

17. The process according to claim 1 wherein the resultant lithium transition metal oxide is at least essentially elliptical.

18. The process according to claim 1 including adding additional M elemental metal and of LiOH to the aqueous solution.

19. The process according to claim 1 wherein the size of the M elemental metal ranges from about 1 μm to 500 μm.

20. The process according to claim 1 wherein the size of the resultant lithium transition metal oxide ranges from about 1 μm to 30 μm.

21. The process according to claim 1 wherein a dopant is introduced into the aqueous solution.

22. The process according to claim 1 wherein the oxidizing environment is created by an electrochemical reaction.

23. The process according to claim 1 wherein the aqueous solution is about one to eight molar lithium hydroxide.
